(19) United States
(12) Patent Application Publication
(10) Pub. No.: US 2016/0256027 A1
(43) Pub. Date: Sep. 8, 2016

(54) Constant Voltage Circuit Module with A Voltage Compensating Unit to Perform Stepless Speed Regulation on a Motor

(71) Applicant: Cheng-chien Chang, New Taipei City (TW)

(72) Inventor: Cheng-chien Chang, New Taipei City (TW)

(21) Appl. No.: 14/997,059

(22) Filed: Jan. 15, 2016

Related U.S. Application Data
(60) Provisional application No. 62/103,972, filed on Jan. 15, 2015.

(51) Int. Cl. A47L 9/28; H02P 7/29

(52) U.S. Cl. CPC A47L 9/2836; H02P 7/29; A47L 9/2884

(57) ABSTRACT

This invention relates to a constant voltage circuit module (“CVCM”), which comprises a control IC board, a power source and a voltage compensating unit. When the CVCM couples with a motor device, the power source contained within provides the driving power the motor device and IC board need and the said IC board may monitor the speed of the motor device and performs stepless speed regulation. The IC board may also display and monitor the storage level of electrical power, if the power source described above is a rechargeable battery or of sort, and stops the motor device when the battery reaches a state of low power or is under charged. This CVCM can be multi-functional and with superior applicability when combined with various electronic appliances, such as the vacuum cleaning appliance. The CVCM may provide multiple safety measures for the coupled motor device by having the IC board control the two circuit modules on the battery and on the board to prevent the motor device from over-charging or over-discharging. One objective of the present invention is to provide stepless speed regulation on the coupled motor device so that the motor device may function at the maximum performance and dramatically reduce the operational noise when the motor runs.

### BACKGROUND OF THE INVENTION

1. Field of the Invention

The present invention relates generally to a constant voltage circuit module with a voltage compensating unit to perform the stepless speed regulation of the motor, and, more specifically to the constant voltage circuit module with multi-functions and superior applicability.

2. Background

The topic disclosure, the constant voltage circuit module, can be applied to various appliances, such as a vacuum cleaning devices. The working mechanism of a vacuum cleaning device is to apply the electric currents to drive a motor to create a suction air flow to remove the surface soil, dirt, dust and particles from the ground surface or any other surfaces that cannot be reached or cleaned with a broom. To add convenience to the regular household cleaning, a portable rechargeable type of vacuum cleaning device was available on the market. However, most rechargeable vacuum cleaning devices simply offer an appliance with a motor driven by the power output generated from a potent rechargeable power source. Once the power switch is on, the motor starts running and the initial strong suction power kicks off. Yet, as the power of the battery is drained by the running motor and other units of the appliance, the motor begins to drag and the suction power thereof gets weaker. Not only is the rotation speed of the motor dropped substantially, but the dragging noise of the motor caused the uneven vibration of the motor also becomes more noticeable. To compensate the voltage loss of the power source can alleviate the aforementioned problems by elevating the output voltage with a pulse width modulation (PWM) method. By compensating the declined voltage, the power device (e.g., the motor) can resume its speed to a state corresponding to the normal prescribed voltage of the power source. Currently there are not many viable solutions available for the rechargeable vacuum cleaning devices on the market or do not offer comparable solutions as the present invention described hereof, at least not to the inventor's awareness, simply because most users of the rechargeable vacuum cleaning device would just put the said device back to the charging station when the suction power thereof wanes due to the drainage of the power source of the said cleaning device. Putting the said device back to the charging station might be a temporary solution to the declining power output problem of the said cleaning device, yet that solution attempts to ignore the deteriorated and insufficient suction power of the said cleaning device while still in use but right before it is put back to the recharging status. That recharging solution also fails to meet the needs of the regular household cleaning because the annoying noise caused by the dragging motor due to the depleted power source.

It would be desirable to have a portable vacuum cleaning device that can deliver constant power output till the last drop of its preserved electric juice. The constant voltage circuit module (hereinafter as “CVCM”) invention when coupled with a power source (e.g., a battery) and a motor device can ensure the constant power delivery from the power source to the motor and maintain the speed of the motor at the top notch in a stepless fashion. Furthermore, it is desirable to have the CVCM monitor the safety of the charging (and discharging) of the power source and stop the motor when the level of the preserved electricity drops too low. Since the CVCM can help the motor run at its peak performance, it helps reduce the dragging noise when the preserved power source progressively depleted during the use of the vacuum cleaning device. Therefore, there is a need of such an invention in the market to maximize the performance of the vacuum cleaning device, to reduce its operation noise and to ensure its charging/discharging safety. Still further, it would be desirable to have a module like this current invention to maximize the motor's performance, to reduce the motor's operational noise, to ensure the safety Of the power source that drives the motor, and to render a few convenient extra features, such as the LED power indicator to display the remaining power of the power source, to the advantage of the users. Therefore, there currently exists a need in the industry of vacuum cleaning devices for the incorporation of the current invention that can compensate the lost voltage of the power source by adopting the constant voltage circuit module.

### SUMMARY OF THE INVENTION

The present invention advantageously fills the aforementioned deficiencies by providing a control IC board comprising a micro control unit, a voltage compensating unit, a speed adjusting unit, a power source monitoring unit, a safety protection unit, a power indicator, an illumination control unit, an illumination device and a power-connecting port. The battery monitoring unit couples a power source, i.e., the battery, while the voltage compensating of the IC control board connects with the battery and perform stepless speed regulation on the motor.

The present invention is a constant voltage circuit module comprising mainly an IC control board with voltage compensating unit, a speed adjusting unit, a battery and a motor. While the control IC board commands the operation of the motor, the voltage of the battery to operate the motor is monitored and compensated via the micro control unit on the IC board simultaneously. The IC board utilizes its voltage compensating unit to command the battery to release an electric energy with a constant voltage to maintain the motor running at a certain speed without losing its momentum, whereas the motor would be stopped in time by the IC board if the battery is detected by the IC board to have met a certain predetermined recharging point (e.g., 20%) when its preserved electricity running too low.

The present invention may. also have one or more of the following: 1. the constant voltage circuit module comprises a voltage compensating unit which is a firmware storing parameters of various motor speeds and respective battery voltage; 2. the constant voltage circuit module comprises a control IC board that may include: (a). a speed adjusting unit coupled with a motor for controlling the various speed of the motor, wherein a speed switch is incorporated to perform the stepless speed regulation upon the motor; (b). a battery monitoring unit, coupled with the battery for monitoring a charging/discharging state of the battery and further introducing a display device to indicate the remaining power of the battery; (c). a safety protection unit, coupled with the speed adjusting unit and the battery monitoring unit to command the speed adjusting unit to stop the motor in case of a state of low power or insufficient charging of the battery detected by the battery monitoring unit; and (d). an illuminating unit, for controlling an illumination unit 3. the speed adjusting unit of the present invention uses a rotor or an electronic switch to adjust a current for driving the motor.

The present invention CVCM is unique in many ways but mostly prominent for the following: 1. the IC control board of the CVCM can elevate the voltage of the power source by storing a set of parameters of motor speeds and its corresponding respective voltages of the power source of the said motor in the firmware of the voltage compensating unit on the control board; 2. the said IC control board thereon can perform stepless speed regulation via the speed adjusting unit on the said board. The speed regulation unit can be operated via the connected speed switch, which can be a rotor or an electronic switch. the board can further monitor the reserved power level of the power source so that the motor can be stopped via the safety protection unit when the remaining power reaches a 20% of the full capacity of electricity that needs to be recharged; 3. the said IC control board thereon is designed and built to accommodate the power source so that 95% of charging currents can be fully transformed into the preserved electric energy saved on the power source and thus extend the service life of the power source. The said control board can also command the safety protection unit thereon to stop the motor and to terminate the transmission of electric energy between the power source and the motor when the reserved power level of the power source reaches a certain low point (e.g., 20%). Moreover, the said control board can automatically stop the operation of the motor while the power source is in charging status and thus enhance the overall usage safety of the appliance which incorporates the CVCM within.

The present invention is unique in that it is structurally different from other known devices or solution because of the presence of the following: 1. the incorporation of micro control unit, voltage compensating unit, the speed adjusting unit, the power source charging/discharging unit, safety protection unit and the motor into the present invention so that the IC control board can work as the command central of the said units to provide the maximum operational efficiency of the motor and also ensure the ultimate safety for the usage of the power source and the appliance that incorporates the present invention; 2. the presence of the voltage compensating unit that may efficiently maintain the constant voltage of the appliance that incorporating the present invention . so that the performance of the said appliance will not deteriorate suddenly while the power source is drained due to the usage.

Among other things, it is an object of the present invention to provide a control IC board comprising a voltage compensating unit to maintain the constant voltage of the power output from the power source and to perform stepless speed regulation on the motor that does not suffer from any of the problems or deficiencies associated with prior solutions.

It is still further an object of the present invention to provide a constant voltage circuit module with 2 safety protection devices: one circuit module on the power source and one on the main control board for preventing the power source from over-charging or over-discharging.

Further still, it is an object of the present invention to provide a stepless speed regulation to control the motor so that the operational noise of such can be significantly reduced.

Further still, it is an object of the present invention to provide a constant voltage and constant speed circuit for maximizing the performance of the motor and precisely computing the operational time of the power source to drive the said motor.

Further still, it is an object of the present invention to provide a constant voltage circuit module comprising an IC control board to perform stepless speed regulation upon the motor, to monitor and display the remaining power of the battery, and to stop the motor while the power source is low or needs to be recharged.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The present invention will now be specified with reference to its preferred embodiment illustrated in the following drawings, in which:

FIG. 1 shows a block diagram of the preferred embodiment of the constant voltage circuit module in accordance with the description of the present invention hereof.

FIG. 2 shows the detailed circuit layout of FIG. 1.

### DETAILED DESCRIPTION OF THE INVENTION

In its most complete version, the current invention presents a constant voltage circuit module, which includes an IC control board that is further comprised of a micro control unit, a speed adjusting unit, a battery monitoring unit, a safety protection unit, a power indicator, an illumination control unit, an illumination device, a voltage compensating unit and a power-connecting port. The battery monitoring unit is coupled with a power source and a motor. The voltage compensating unit on the IC control board is further connected with a battery and the motor.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

### Additional Information

The present CVCM invention is a multi-functional invention with superior applicability. The typical embodiment of the present invention is a vacuum cleaning device, especially a portable, rechargeable type of vacuum cleaner. However, with a slight modification, the CVCM can be fitted with a juicer, a blender or any other machines that dictate a dire need of constant voltage and constant speed operation of the motor that draws power from the rechargeable power source.

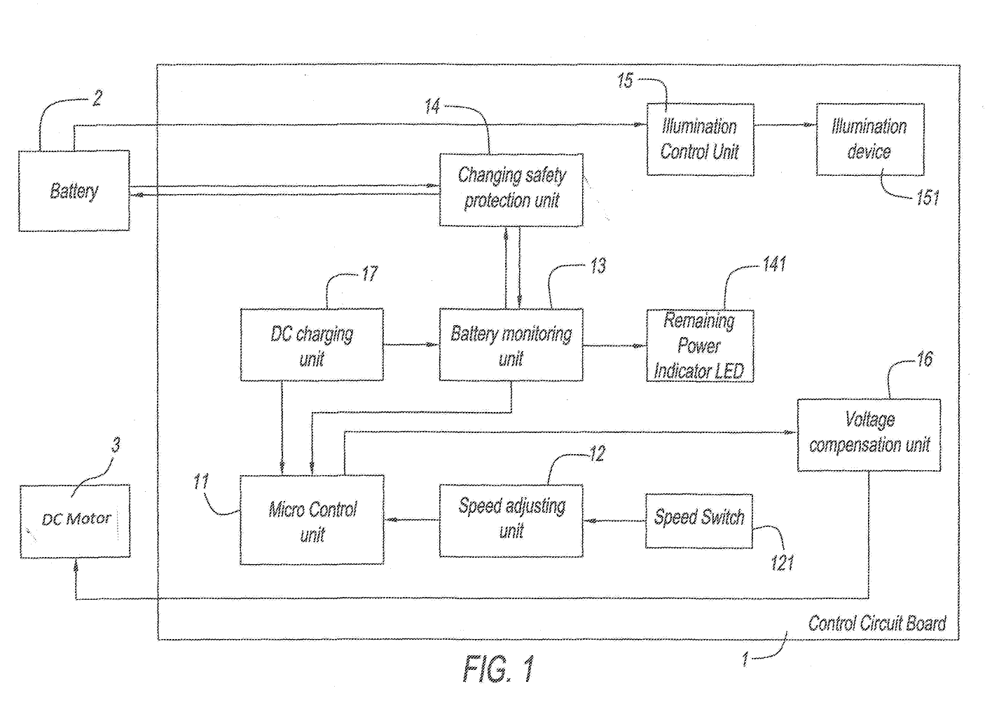

### FIG. 1

1. Control circuit Board

2. Battery

3. DC Motor

11. Micro control unit

12. Speed-adjusting unit

121. Speed switch

13. Battery-monitoring unit

14. Safety-protection unit

141. Remaining power indicator LED

15. Illumination-control unit

151. Illumination device

16. Voltage compensating unit

17. Direct Current (DC) charging unit

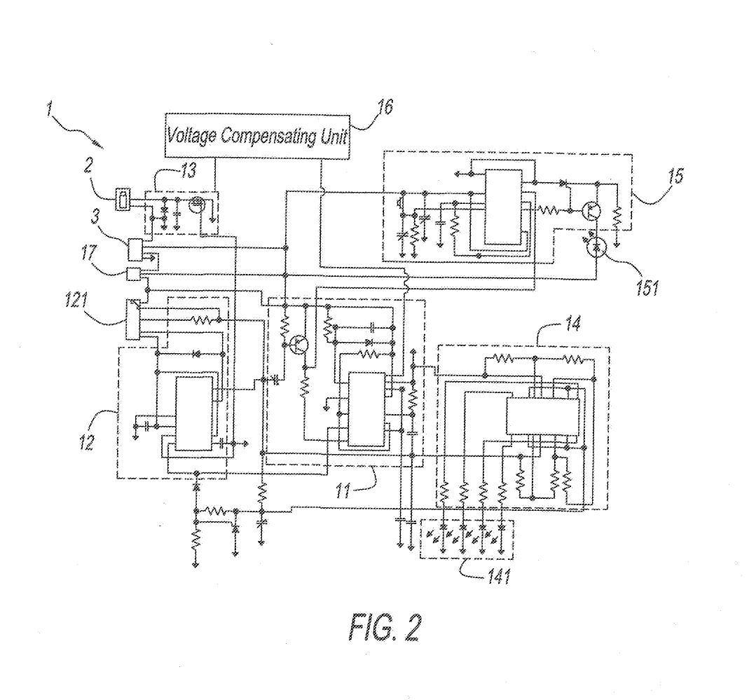

### FIG. 2

16. Voltage compensating unit

1. A rechargeable vacuum cleaning device equipped with a constant voltage circuit module (CVCM), said CVCM comprising an integrated circuit (IC) control board that can control the rotation speed of the motor of the said vacuum cleaning device in a stepless approach, said IC board having a micro control unit, a motor rotation speed control unit, a power supply monitoring unit, a circuit breaker protection unit, a power storage indication unit, an illumination control unit, an lighting source, an enhanced voltage frequency monitoring unit, and a direct current (DC) recharging unit, said power supply coupled with a DC motor, said enhanced voltage monitoring unit connected to the power supply and the said DC motor, said power supply releasing power to drive said DC motor, the said micro control unit controlling the power supply to reinforce the voltage when the power supply gradually depleted due to the usage of the said vacuum cleaning device, or to stop the running of the motor if the power too weak to run the motor or the said cleaning device needed to be recharged,
means for coupling the said CVCM to the said vacuum cleaning device to regulate the release of power from the power supply and to maintain the desired constant voltage for operation of the said cleaning device.

2. The said vacuum cleaning device for claim 1 having means for elevating the output voltage of the power with pulse width modulation (PWM) method to keep the DC motor of the said vacuum cleaning device running at the normal speed even when the power storage of the said cleaning device having been drained.

3. Means for having the CVCM installed on appliances that need to keep a constant voltage for a fixed running speed of the motor, like a blender, remote toy vehicles, and or other applications.
